(19) United States
(12) Patent Application Publication
(10) Pub. No.: US 2026/0066300 A1
(43) Pub. Date: Mar. 5, 2026

(54) POSITIVE ELECTRODE AND RECHARGEABLE LITHIUM BATTERY INCLUDING THE SAME

(71) Applicant: SAMSUNG SDI CO., LTD., Yongin-si (KR)

(72) Inventors: Seunghyun JEON, Yongin-si (KR); Hyunwoo KIM, Yongin-si (KR); Moonju CHO, Yongin-si (KR); Seunghyun LIM, Yongin-si (KR); Beom Kwon KIM, Yongin-si (KR); Youngkwang CHO, Yongin-si (KR); Seung-Hun HAN, Yongin-si (KR)

(73) Assignee: SAMSUNG SDI CO., LTD., Yongin-si (KR)

(21) Appl. No.: 19/311,719

(22) Filed: Aug. 27, 2025

(30) Foreign Application Priority Data
Aug. 29, 2024 (KR) 10-2024-0117148

(51) Int. Cl. H01M 4/62; H01M 4/02; H01M 4/131; H01M 4/133; H01M 4/134; H01M 4/38; H01M 4/525; H01M 4/587; H01M 10/0525; H01M 10/42

(52) U.S. Cl. CPC H01M 4/62; H01M 4/131; H01M 4/133; H01M 4/134; H01M 4/386; H01M 4/387; H01M 4/525; H01M 4/587; H01M 10/4235; H01M 2004/021; H01M 2004/027; H01M 2004/028; H01M 10/0525

(57) ABSTRACT

The present disclosure discloses a positive electrode including a current collector, and a positive electrode active material layer on the current collector. The positive electrode active material layer includes a positive electrode active material, boron nitride, and polyethylene oxide. The present disclosure also discloses a rechargeable lithium battery including the positive electrode.

### CROSS-REFERENCE TO RELATED APPLICATION

This application claims priority to Korean Patent Application No. 10-2024-0117148 filed in the Korean Intellectual Property Office on Aug. 29, 2024, the entire contents of which are incorporated herein by reference.

### BACKGROUND

### 1. Field

The present disclosure relates to a positive electrode, and a rechargeable lithium battery including the positive electrode.

### 2. Description of the Related Art

With increasing presence of electronic devices that use batteries, such as, e.g., mobile phones, laptop computers, electric vehicles, and the like, the demand for rechargeable batteries with high energy density and high capacity is increasing. Accordingly, improving the performance of rechargeable lithium batteries may be advantageous.

Rechargeable lithium batteries typically include a positive electrode and a negative electrode including an active material capable of intercalating and deintercalating lithium ions, and an electrolyte solution, and generate electrical energy through oxidation and reduction reactions when lithium ions are intercalated and deintercalated from the positive electrode and the negative electrode.

Because the rechargeable lithium batteries, which are recharged after the discharge and continuously used, exhibit performance differences depending on their charging and discharging state, efforts to improve the performance of the rechargeable lithium batteries by improving a charge method may be advantageous.

As high energy density and high capacity batteries are in demand, the upper limit charge voltage of a battery desired by the market is increasing. Accordingly, the positive electrode voltage level increases, causing a phase change in the positive electrode active material. At this time, the side reaction is accelerated due to the active oxygen generated, which causes a decrease in the capacity of the battery and a deterioration in the cycle-life.

### SUMMARY

Some example embodiments include a positive electrode capable of reducing or preventing deterioration of the electrode while maintaining lithium ionic conductivity, and a rechargeable lithium battery including the positive electrode having improved cycle-life characteristics.

Some example embodiments include a positive electrode including a current collector, and a positive electrode active material layer on the current collector, wherein the positive electrode active material layer includes a positive electrode active material, boron nitride (BN), and polyethylene oxide (PEO).

Some example embodiments include a rechargeable lithium battery including the positive electrode, a negative electrode including a negative electrode active material layer, and an electrolyte.

The positive electrode according to some example embodiments has an advantage of reducing or preventing deterioration of the electrode while maintaining lithium ionic conductivity, and a rechargeable lithium battery including the positive electrode has an advantage of improved cycle-life characteristics.

### BRIEF DESCRIPTION OF THE DRAWINGS

FIG. 1 to FIG. 4 are cross-sectional views schematically illustrating rechargeable lithium batteries according to some example embodiments.

### DETAILED DESCRIPTION

Hereinafter, example embodiments are described in detail. However, these embodiments are presented as an example, and the present disclosure is not limited thereto, and the present disclosure is defined by the scope of the claims described below.

The terminology used herein is used to describe example embodiments only, and is not intended to limit the present disclosure. The singular expression includes the plural expression unless the context clearly dictates otherwise.

As used herein, “combination thereof” indicates a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but does not preclude the possibility of the presence or addition of one or more other features, number, step, element, or a combination thereof.

In the drawings, the thickness of layers, films, panels, regions, and the like, may be exaggerated for clarity, and like reference numerals designate like elements throughout the specification. It is understood that when an element such as a layer, film, region, or substrate is referred to as being “on” another element, the element can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Unless otherwise specified in this specification, what is indicated in the singular may also include the plural. In addition, unless otherwise specified, “A or B” may mean “including A, including B, or including A and B”.

“Metal” is interpreted as a concept including ordinary metals, transition metals and metalloids (semi-metals).

As used herein, when a definition is not otherwise provided, the particle diameter may be an average particle diameter. In addition, the particle diameter may refer to an average particle diameter (D50), which indicates the diameter of particles having a cumulative volume of 50 volume % in the particle size distribution. The average particle size (D50) may be measured by a method known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D50) value may be easily obtained through a calculation. Alternatively, the average particle diameter (D50) value can be measured using a laser diffraction method. When measuring by the laser diffraction method, for example, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D50) on the basis of 50% of the particle diameter distribution in the measuring device.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Positive Electrode

A positive electrode according to some example embodiments includes a current collector, and a positive electrode active material layer on the current collector. The positive electrode active material layer includes positive electrode active material, boron nitride, and polyethylene oxide.

Conventionally, when a rechargeable lithium battery including a ternary positive electrode active material is operated at a high voltage, there may be an issue in that the ternary positive electrode active material is reduced by the electrolyte solution and other impurities, generating active oxygen (O₂⁻, O⁻, O₂²⁻, and the like), which may accelerate battery side reactions and thus deteriorate the cycle-life of the battery.

According to some example embodiments, a positive electrode for a rechargeable lithium battery includes boron nitride (BN), and boron atoms in the boron nitride can help ensure oxidation stability of an electrolyte solution by trapping PF₆⁻, which may be generated by decomposition of a lithium salt (e.g., LiPF₆).

In addition, the boron nitride may adsorb the active oxygen, thereby reducing or preventing oxidation reaction at the interface of the positive electrode active material, thereby reducing or preventing deterioration of the electrode, and consequently improving cycle-life characteristics of the rechargeable lithium battery.

For example, the boron nitride may have a hexagonal crystal structure.

The boron nitride having the hexagonal crystal structure has a structure similar to graphite, and each layer thereof can form a hexagonal network by alternating boron atoms and nitrogen atoms.

For example, when boron nitride having the hexagonal crystal structure is included, the decomposition product of lithium salt can be effectively trapped, and active oxygen can be efficiently adsorbed.

For example, the boron nitride may be included in an amount in a range of about 0.1 wt % to about 5 wt %, for example, about 1 wt % to about 5 wt %, about 0.1 wt % to about 3 wt %, or about 1 wt % to about 3 wt % based on 100 wt % of the positive electrode active material layer.

When the boron nitride is included in an amount that is less than about 0.1 wt % based on 100 wt % of the positive electrode active material layer, it may be difficult to effectively reduce or prevent deterioration of the electrode, and when the boron nitride is included in an amount exceeding about 5 wt %, the resistance within the positive electrode may increase, thereby lowering the lithium ionic conductivity.

The boron nitride may be or include a compound having a long aspect ratio, and accordingly, when a large amount of boron nitride is added to the positive electrode, there may be a challenge in that the boron nitride may act as a resistor within the positive electrode, thereby deteriorating cell characteristics. The positive electrode according to some example embodiments includes polyethylene oxide (PEO) having high ionic conductivity together with boron nitride, thereby improving charge-discharge characteristics of a battery without increasing the resistance of the positive electrode.

For example, within the positive electrode, the polyethylene oxide may be located in the form of a coating layer on the surface of the positive electrode active material, and the boron nitride may be located between the positive electrode active materials. When polyethylene oxide and boron nitride exist in the positive electrode in the form described above, the lithium ionic conductivity of the positive electrode can be effectively reduced or prevented while maintaining deterioration of the positive electrode.

For example, the polyethylene oxide may be included in an amount in a range of about 0.01 wt % to about 1 wt %, for example, about 0.05 wt % to about 1 wt %, about 0.01 wt % to about 0.5 wt %, about 0.05 wt % to about 0.5 wt %, about 0.1 wt % to about 0.5 wt %, or about 0.1 wt % to about 0.4 wt % based on 100 wt % of the positive electrode active material layer. When the polyethylene oxide is included in an amount that is less than about 0.01 wt % based on 100 wt % of the positive electrode active material layer, the resistance of the positive electrode may increase, and when the polyethylene oxide is included in an amount that is more than about 1 wt % based on 100 wt % of the positive electrode active material layer, deterioration of the electrode may occur.

For example, the weight ratio of the boron nitride to the polyethylene oxide may be in a range of about 500:1 to about 1:1, for example about 250:1 to about 3:1, about 200:1 to about 5:1, about 100:1 to about 5:1, about 50:1 to about 5:1, about 30:1 to about 5:1, about 30:1 to about 7.5:1, about 20:1 to about 10:1, or about 20:1 to about 15:1.

For example, in order to confirm the presence, distribution, and content of boron nitride and polyethylene oxide included in the positive electrode, an analysis method using a scanning electron microscope (SEM) may be used. For example, the presence and shape of boron nitride and polyethylene oxide distributed on the surface of the positive electrode active material may be confirmed through SEM analysis. In addition, the content of boron nitride and polyethylene oxide can be quantitatively analyzed through energy dispersive X-ray spectroscopy (EDS) analysis using SEM.

The positive electrode active material may include a compound (lithiated intercalation compound) capable of intercalating and deintercalating lithium. For example, at least one of a composite oxide of lithium and a metal such as or including at least one of cobalt, manganese, nickel, and combinations thereof may be included. The composite oxide may be or include a lithium transition metal composite oxide.

In some example embodiments, the positive electrode active material may include lithium cobalt-based oxide represented by Chemical Formula 1.

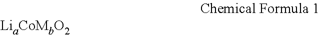

In Chemical Formula 1, M may be or include at least one of Al, Cr, Mn, Fe, Mg, La, Ce, Sr, V, W, Mo, Zr, Ti, Ta, Nb, or a combination thereof, 0.90≤a≤1.8, and 0≤b≤0.1.

In general, when adding additives other than active materials to the positive electrode active material layer, a challenge of lowering energy density may occur.

For example, the lithium cobalt-based oxide may be or include an amorphous active material, and because such an amorphous active material is better pressed during the compression process of the positive electrode compared to a spherical active material (e.g., a nickel-based positive electrode active material), the energy density may be hindered or prevented from being lowered. Therefore, when the lithium cobalt-based oxide is included as a positive electrode active material, even when additives such as the boron nitride and polyethylene oxide are added to the positive electrode active material layer, there is an advantage in that an energy density equivalent to the case where no additives are added can be maintained.

For example, the positive electrode active material may further include at least one of a lithium nickel-based oxide, a lithium manganese-based oxide, a lithium iron phosphate-based compound, a cobalt-free lithium nickel-manganese-based oxide, or a combination thereof.

For example, the positive electrode active material may further include a compound represented by one of the following chemical formulas.

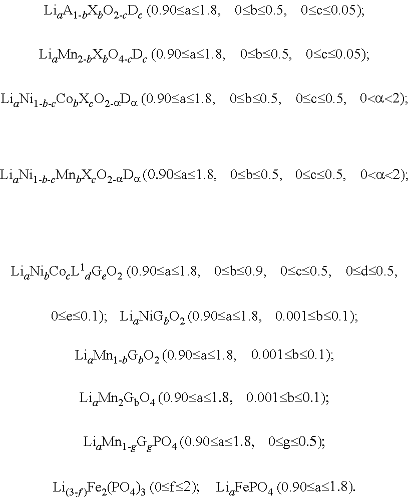

In the above chemical formulas, A is or includes at least one of Ni, Co, Mn, or a combination thereof; X is or includes at least one of AI, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol %, based on 100 mol % of the metal excluding lithium in the lithium transition metal composite oxide. The high-nickel positive electrode active materials can achieve high capacity, and can be applied to high-capacity, high-density rechargeable lithium batteries.

For example, a content of the positive electrode active material may be in a range of about 90 wt % to about 99.5 wt % based on 100 wt % of the positive electrode active material layer.

For example, the active material layer may further include a binder and/or a conductive material. Herein, amounts of the binder and the conductive material may be in a range of about 0.5 wt % to about 5 wt %, respectively, based on 100 wt % of the positive electrode active material layer.

The binder is configured to attach the positive electrode active material particles to each other, and to attach the positive electrode active material to the current collector. Examples of the binder may include at least one of polyvinyl alcohol, carboxymethylcellulose, hydroxypropylcellulose, diacetylcellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, but are not limited thereto.

The conductive material is included to impart conductivity to the electrode, and any material that does not cause chemical change and conducts electrons can be included in the battery. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

The current collector may be made of or include Al, but is not limited thereto.

For example, an active mass density of the positive electrode may be in a range of about 4.1 g/cc to about 4.3 g/cc, for example about 4.15 g/cc to about 4.3 g/cc, about 4.1 g/cc to about 4.25 g/cc, about 4.15 g/cc to about 4.25 g/cc, or about 4.15 g/cc to about 4.2 g/cc.

### Negative Electrode

The negative electrode for a rechargeable lithium battery includes a current collector, and a negative electrode active material layer on the current collector. The negative electrode active material layer may include a negative electrode active material, and may further include a binder and/or a conductive material.

The negative electrode active material may include at least one of a material that reversibly intercalates/deintercalates lithium ions, a lithium metal, a lithium metal alloy, a material capable of doping/dedoping lithium, or a transition metal oxide.

For example, the negative electrode active material may include at least one of a carbon-based negative electrode active material, a Si-based negative electrode active material, a Sn-based negative electrode active material, or a combination thereof.

The material that reversibly intercalates/deintercalates lithium ions may include a carbon-based negative electrode active material, for example crystalline carbon, amorphous carbon or a combination thereof. The crystalline carbon may be or include graphite such as non-shaped, sheet-shaped, flake-shaped, sphere-shaped, or fiber-shaped natural graphite or artificial graphite, and the amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to some example embodiments, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be included in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder is configured to attach the negative electrode active material particles to each other, and to attach the negative electrode active material to the current collector. The binder may include at least one of a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is included as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material capable of being fibrous, and may be or include, for example, at least one of polytetrafluoroethylene, polyvinylidene fluoride, a polyvinylidene fluoride-hexafluoropropylene copolymer, polyethylene oxide, or a combination thereof.

The conductive material is included to impart conductivity to the electrode, and any material that does not cause chemical change and conducts electrons can be included in the battery. Examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative electrode current collector may include at least one of a copper foil, a nickel foil, a stainless steel foil, a titanium foil, a nickel foam, a copper foam, a polymer substrate coated with a conductive metal, and a combination thereof.

### Electrolyte Solution

The electrolyte solution for a rechargeable lithium battery may include a non-aqueous organic solvent and a lithium salt.

The non-aqueous organic solvent is configured as a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. The alcohol-based solvent may include at least one of ethanol, isopropyl alcohol, and the like. The aprotic solvent may include at least one of nitriles such as R-CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvents may be included alone or in combination of two or more solvents.

In addition, when using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. For example, the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(CyF_{2y+1}SO₂), x and y are integers of 1 to 20, lithium trifluoromethane sulfonate, lithium tetrafluoroethanesulfonate, lithium difluorobis(oxalato)phosphate (LiDFOB), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including at least one of an organic material, an inorganic material, or a combination thereof on one surface, or on both surfaces, of the porous substrate.

The porous substrate may be or include a polymer film formed of or including any one or more of polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Rechargeable Lithium Battery

In some example embodiments, a rechargeable lithium battery including the aforementioned positive electrode is provided.

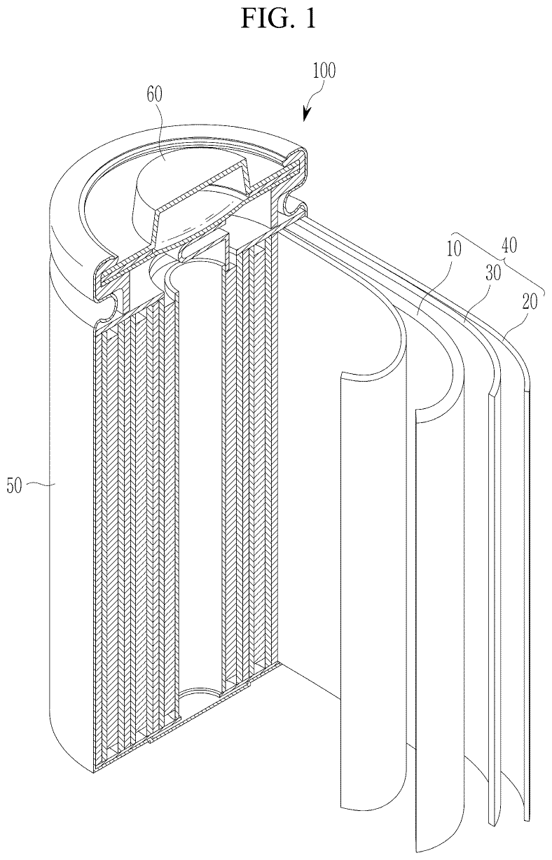

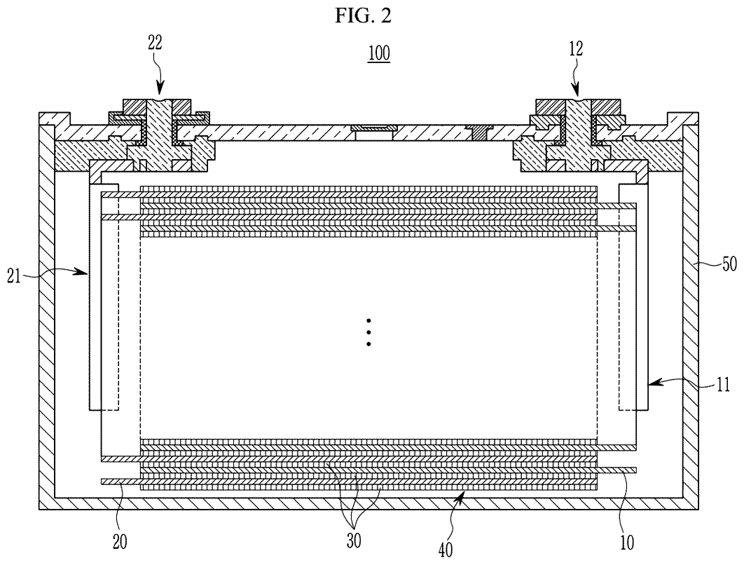

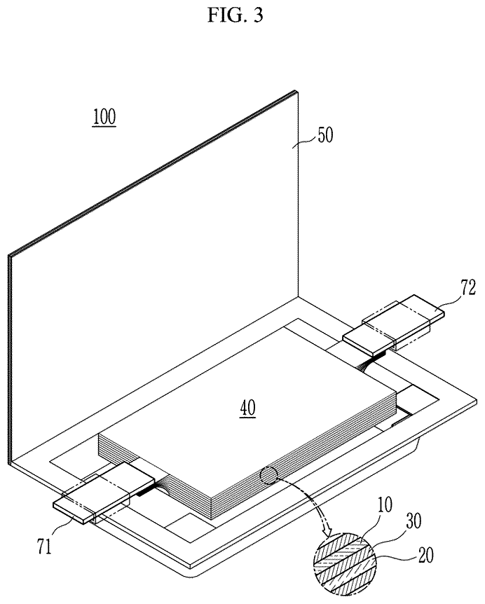

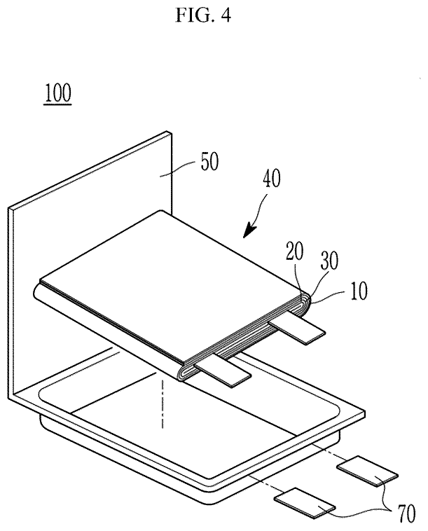

The rechargeable lithium battery may be classified into cylindrical, prismatic, pouch, coin, and the like depending on their shape. FIG. 1 to FIG. 4 are schematic views illustrating a rechargeable lithium battery according to some example embodiments. FIG. 1 illustrates a cylindrical battery, FIG. 2 illustrates a prismatic battery, and FIG. 3 and FIG. 4 illustrate pouch-type batteries. Referring to FIG. 1 to FIG. 4, the rechargeable lithium battery 100 includes an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The rechargeable lithium battery 100 may include a sealing member 60 that seals the case 50, as illustrated in FIG. 1, and in FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIG. 3 and FIG. 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

The rechargeable lithium battery according to an example embodiment may be applicable to, e.g., automobiles, mobile phones, and/or various types of electric devices, but the present disclosure is not limited thereto.

For example, the upper limit charge voltage of the rechargeable lithium battery may be greater than or equal to about 4.5 V, and as an example, the upper limit charge voltage of the rechargeable lithium battery may be greater than or equal to about 4.53 V.

According to some example embodiments, a rechargeable lithium battery can reduce or prevent deterioration of the electrode while maintaining lithium ionic conductivity by including both the boron nitride and polyethylene oxide in the positive electrode when operating at a high voltage that is greater than or equal to about 4.5 V.

For example, the higher the upper limit charge voltage of the rechargeable lithium battery, the more the effect of reducing or preventing electrode deterioration by adding boron nitride is maximized, and thus the cycle-life characteristics of the battery can be improved, or significantly improved.

Examples and comparative examples of the present disclosure are described below. However, the following examples are only examples of the present disclosure, and the present disclosure is not limited to the following examples.

### EXAMPLES

### Example 1

First, 96 wt % of LiCoO₂, 2 wt % of Ketjen black, and 2 wt % of polyvinylidene fluoride were mixed in N-methyl pyrrolidone as a solvent. Subsequently, the obtained mixture was mixed with boron nitride having a hexagonal system crystal structure (hereinafter, referred to as H-BN) and polyethylene oxide (hereinafter, referred to as PEO) to prepare a positive electrode active material slurry. The positive electrode active material slurry was coated on an Al current collector, and then dried and compressed to manufacture a positive electrode having a positive electrode active material layer on the Al current collector.

Herein, based on 100 wt % of positive electrode active material layer, the H-BN was included in an amount of 3 wt %, while the PEO were included in an amount of 0.1 wt %.

Subsequently, a negative electrode active material slurry was prepared by mixing 97.5 wt % of artificial graphite, 1.0 wt % of carboxylmethyl cellulose, and 1.5 wt % of a styrene butadiene rubber (SBR) in water as a solvent. The negative electrode active material slurry was coated on a copper current collector, and then dried and compressed to manufacture a negative electrode.

The positive electrode and the negative electrode were used with a polyethylene separator and an electrolyte, which was prepared by dissolving 1.15 M LiPF₆ in a mixed solvent of EC (ethylenecarbonate):EMC (ethylmethylcarbonate):DMC (dimethylcarbonate) (in a volume ratio of 3:3:4), to manufacture a rechargeable lithium battery cell according to Example 1.

### Examples 2 to 3 and Comparative Examples 1 to 3

A positive electrode, and a rechargeable lithium battery cell including the positive electrode, were manufactured in the same manner as in Example 1, with a difference that the H-BN and PEO contents (wt %) of the positive electrode were respectively changed as shown in Table 1 below.

### EVALUATION EXAMPLES

### Evaluation Example 1: Cycle-Life Retention Rate at 25° C. (Room Temperature)

First, the rechargeable lithium battery cells according to Examples 1 to 3 and Comparative Examples 1 to 2 were evaluated with respect to cycle-life retention rates at room temperature, when operated at an upper limit charge voltage of 4.5 V.

Specifically, the rechargeable lithium battery cells were charged to a voltage of 4.5 V at a constant current of 0.2 C and to a current of 0.02 C at the constant voltage of 4.5 V at 25° C. Subsequently, the cells were discharged to a voltage of 2.75 V at the constant current of 0.2 C. This operation may be referred to as a Formation step.

Subsequently, the cells were charged to a voltage of 4.16 V at a constant current of 1.3 C and to a current of 1.0 C at the constant voltage of 4.16 V. Next, the cells were charged to a voltage of 4.28 V at the constant current of 1.0 C and to a current of 0.8 C at the constant voltage of 4.28 V. Then, the cells were charged to a voltage of 4.5 V at the constant current of 0.8 C and to a current of 0.1 C at the constant voltage of 4.5 V. The cells were then discharged to a voltage of 3.2 V at a constant current of 0.5 C. This operation may be referred to as a Standard step.

Table 1 below shows the room temperature cycle-life retention rate (%) results of the cells according to Examples 1-1, 2-1, and 3-1 and Comparative Examples 1-1 and 2-1 after 300 cycles repeating the standard step. (Upper limit charge voltage: 4.5 V)

Subsequently, the rechargeable lithium battery cells according to Examples 1 to 3 and Comparative Examples 1 to 2 were evaluated with respect to room temperature cycle-life retention rates, when operated at an upper limit charge voltage of 4.53 V.

Specifically, the rechargeable lithium battery cells were charged to a voltage of 4.5 V at a constant current of 0.2 C and to a current of 0.02 C at the constant voltage of 4.5 V at 25° C. Subsequently, the cells were discharged to a voltage of 2.75 V at the constant current of 0.2 C. This operation may be referred to as the Formation step. Next, the cells were charged to a voltage of 4.16 V at a constant current of 1.3 C and to a current of 1.0 C at the constant voltage of 4.16 V. Then, the cells were charged to a voltage of 4.28 V at the constant current of 1.0 C and to a current of 0.8 C at the constant voltage of 4.28 V. Subsequently, the cells were charged to a voltage of 4.53 V at the constant current of 0.8 C and to a current of 0.1 C at the constant voltage of 4.53 V. The cells were discharged to a voltage of 3.2 V at a constant current of 0.5 C. This operation may be referred to as the Standard step.

Table 1 shows the room temperature cycle-life retention rate (%) results of Examples 1-2, 2-2, and 3-2 and Comparative Examples 1-2 and 2-2 after 300 cycles repeating the standard step. (upper limit charge voltage: 4.53 V)

### Evaluation Example 2: Cycle-Life Retention Rate at 45° C. (High Temperature)

The charging and discharging experiment was performed by 300 cycles in total repeatedly charging and discharging the cells in the same manner as in Evaluation Example 1, with a difference that the temperature was changed from 25° C. to 45° C. As in Evaluation Example 1, Table 1 below shows high-temperature (45° C.) cycle-life characteristics at each upper limit charge voltage of 4.5 V and 4.53 V.

TABLE 1

| | | | | 25° C. (room | 45° C. (high |
|---|---|---|---|---|---|
| | | | | temperature) | temperature) |
| | | | | cycle-life | cycle-life |
| | | | | retention rate | retention rate |
| | Structure of positive | Upper limit | | (%) | (%) |
| | electrode | charge voltage | | @ 300 cycles | @ 300 cycles |
| Example 1-1 | LCO + H-BN 3 wt % + | 4.5 | V | 86.8% | 86.6% |
| | PEO 0.1 wt % | | | | |
| Example 1-2 | LCO + H-BN 3 wt % + | 4.53 | V | 86.6% | 84.0% |
| | PEO 0.1 wt % | | | | |
| Example 2-1 | LCO + H-BN 3 wt % + | 4.5 | V | 87.3% | 86.9% |
| | PEO 0.2 wt % | | | | |
| Example 2-2 | LCO + H-BN 3 wt % + | 4.53 | V | 86.9% | 84.4% |
| | PEO 0.2 wt % | | | | |
| Example 3-1 | LCO + H-BN 3 wt % + | 4.5 | V | 86.9% | 86.5% |
| | PEO 0.4 wt % | | | | |
| Example 3-2 | LCO + H-BN 3 wt % + | 4.53 | V | 86.6% | 84.1% |
| | PEO 0.4 wt % | | | | |
| Comparative | LCO | 4.5 | V | 87.5% | 85.3% |
| Example 1-1 | | | | | |
| Comparative | LCO | 4.53 | V | 85.5% | 80.8% |
| Example 1-2 | | | | | |
| Comparative | LCO + H-BN 3 wt % | 4.5 | V | 86.6% | 86.5% |
| Example 2-1 | | | | | |
| Comparative | LCO + H-BN 3 wt % | 4.53 | V | 86.6% | 83.9% |
| Example 2-2 | | | | | |

Referring to Table 1, comparing the results of the examples (Examples 1-1, 2-1, and 3-1) and the comparative examples (Comparative Examples 1-1 and 2-1) at the upper limit charge voltage of 4.5 V, the examples exhibited equivalent or lower room temperature cycle-life retention rates and desired or improved high temperature cycle-life retention rates.

In addition, comparing the results of the examples (Examples 1-2, 2-2, and 3-2) and the comparative examples (Comparative Examples 1-2 and 2-2) at the upper limit charge voltage of 4.53 V, the examples exhibited equivalent or higher room temperature cycle-life retention rates and desired or improved high temperature cycle-life retention rates.

Accordingly, the effect of the example embodiments of the present disclosure at the upper limit charge voltage of 4.53 V, which is higher than 4.5 V, was desired or improved. This may be due to the fact that H-BN may constitute a resistor at 4.5 V and may improve oxidation safety at 4.53 V.

In addition, comparing Example 1-1 with Comparative Example 2-1, and Example 1-2 with Comparative Example 2-2, shows that Comparative Examples 2-1 and 2-2, which included no PEO capable of increasing lithium ionic conductivity, had higher resistance in the positive electrodes and exhibited a lower cycle-life retention rate than Examples 1-1 and 1-2.

While this disclosure has been described in connection with what is presently considered to be practical example embodiments, it is to be understood that the disclosure is not limited to the disclosed example embodiments, but, on the contrary, is intended to cover various modifications and equivalent arrangements included within the spirit and scope of the appended claims.

### DESCRIPTION OF SYMBOLS

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A positive electrode, comprising:
a current collector and a positive electrode active material layer on the current collector,
wherein the positive electrode active material layer comprises a positive electrode active material, boron nitride, and polyethylene oxide.

2. The positive electrode as claimed in claim 1, wherein:
the boron nitride has a hexagonal system crystal structure.

3. The positive electrode as claimed in claim 1, wherein:
the boron nitride is included in an amount in a range of about 0.1 wt % to about 5 wt % based on 100 wt % of the positive electrode active material layer.

4. The positive electrode as claimed in claim 1, wherein:
the polyethylene oxide is included in an amount in a range of about 0.01 wt % to about 1 wt % based on 100 wt % of the positive electrode active material layer.

5. The positive electrode as claimed in claim 1, wherein:
a weight ratio of the boron nitride to the polyethylene oxide is in a range of about 500:1 to about 1:1.

6. The positive electrode as claimed in claim 1, wherein:
the positive electrode active material comprises lithium cobalt-based oxide represented by Chemical Formula 1: 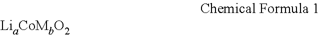
wherein, in Chemical Formula 1,
M comprises at least one of Al, Cr, Mn, Fe, Mg, La, Ce, Sr, V, W, Mo, Zr, Ti, Ta, and Nb,

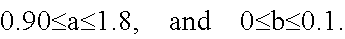

7. The positive electrode as claimed in claim 1, wherein:
a content of the positive electrode active material is in a range of about 94 wt % to about 99.5 wt % based on 100 wt % of the positive electrode active material layer.

8. The positive electrode as claimed in claim 1, wherein:
the positive electrode has an active mass density in a range of about 4.1 g/cc to about 4.3 g/cc.

9. A rechargeable lithium battery, comprising:
the positive electrode as claimed in claim 1;
a negative electrode comprising a negative electrode active material; and
an electrolyte.

10. The rechargeable lithium battery as claimed in claim 9, wherein:
the negative electrode active material comprises at least one of a carbon-based negative electrode active material, a Si-based negative electrode active material, and a Sn-based negative electrode active material.

11. The rechargeable lithium battery as claimed in claim 10, wherein:
the carbon-based negative electrode active material comprises at least one of crystalline carbon, and amorphous carbon.

12. The rechargeable lithium battery as claimed in claim 10, wherein:
the Si-based negative electrode active material comprises at least one of silicon, a silicon-carbon composite, and SiOx (0<x≤2).

13. The rechargeable lithium battery as claimed in claim 10, wherein:
the Sn-based negative electrode active material comprises at least one of Sn, SnO₂, and a Sn-based alloy.

14. The rechargeable lithium battery as claimed in claim 9, wherein:
an upper limit charging voltage of the rechargeable lithium battery is greater than or equal to about 4.5 V.

15. The rechargeable lithium battery as claimed in claim 9, wherein:
an upper limit charging voltage of the rechargeable lithium battery is greater than or equal to about 4.53 V.
